(19) United States
(12) Patent Application Publication
(10) Pub. No.: US 2005/0015480 A1
(43) Pub. Date: Jan. 20, 2005

(54) Devices for monitoring digital video signals and associated methods and systems

(76) Inventor: James L. Foran, San Jose, CA (US)

Correspondence Address: STERNE, KESSLER, GOLDSTEIN & FOX PLLC, 1100 NEW YORK AVENUE, N.W., WASHINGTON, DC, 20005, US

(21) Appl. No.: 10/429,257

(22) Filed: May 5, 2003

(51) Int. Cl. G06F 15/173

(52) U.S. Cl. 709/224

(57) ABSTRACT

Data related to information displayed on a local display unit is formed into a data transfer protocol format (e.g., Internet Protocol (IP)). Typically, the data is captured before it is formed into the data transfer protocol format. The formed data is transmitted through a network. The transmitted data is received at a remote computer station. The received data is converted to a visual display (pixel) format (e.g., Digital Visual Interface (DVI)). Typically, the converted data is stored in a frame buffer of the remote computer station. The converted data is displayed on a remote display unit of the remote computer station.

### BACKGROUND OF THE INVENTION

1. Field of the Invention

The present invention relates to digital video monitoring and display.

2. Background Art

Monitoring systems are used to monitor multiple display units. For example, a monitoring system allows a supervisor or a commander to monitor activity across a number of display units. Some monitoring systems also allow a supervisor or a commander to select and place individual screens or portions of screens on a large multi-person viewable display system. Monitoring systems are used in a variety of applications including, but not limited to, security, surveillance, education, battlefield command and control, observation of manufacturing or repair processes (particularly in harsh environments), teleconferencing, air traffic control, television program production, control of space vehicles, observation of securities exchange activities, and endoscopic surgery.

Implementations of monitoring systems, however, have drawbacks. One approach is to use a video switching network. A video switching network controls the distribution of video between the monitoring system and display units. The video switching network is limited in that it needs to be customized for a specific application. Another approach is to use a customized monitoring system with compatible display unit equipment, such as compatible software and hardware at each display unit and associated computers coupled to the display units. Such customization and compatibility requirements do not allow a monitoring system to be implemented across heterogeneous display units of varying type and vendor. This can increase the cost of implementing a monitoring system, especially if more inexpensive or legacy display units or computers cannot be accommodated.

### BRIEF SUMMARY OF THE INVENTION

The present invention overcomes the above problems and provides further features and advantages. The inventor recognized that what is needed is a monitoring system and method that leverages the emergence of digital video links between display units and computers as well as the availability of high speed digital networking.

The present invention relates to devices for monitoring digital video signals and associated methods and systems. The present invention comprises a method for monitoring information displayed on a local display unit at a remote computer station. In an embodiment, the remote computer station can continuously monitor information displayed on the local display unit. In another embodiment, the remote computer station can selectively monitor information displayed on the local display unit by having a local controller respond to a signal from the remote computer station. Optionally, the controller can prevent transmission of the formed data through the network.

Data related to information displayed on the local display unit is formed into a data transfer protocol format (e.g., Internet Protocol (IP)). Typically, the data is captured before it is formed into the data transfer protocol format. Optionally, the data is compressed before it is formed into the data transfer protocol format. Optionally, the data is encrypted before it is formed into the data transfer protocol format. The formed data is transmitted through a network. The transmitted data is received at the remote computer station. The received data is converted to a visual display (pixel) format (e.g., Digital Visual Interface (DVI)). Typically, the converted data is stored in a frame buffer of the remote computer station. Optionally, the converted data is decrypted. Optionally, the converted data is decompressed. The converted data is displayed on a remote display unit of the remote computer station.

In an embodiment, the method can include a plurality of local display units such that the information displayed on at least one of the plurality of local display units can be displayed on the remote display unit. Optionally, at least one of the plurality of local display units can be selected to display its information. Optionally, a screen of the remote display unit can be tiled into a plurality of tile portions, wherein a tile portion of the plurality of tile portions can display one of the plurality of local display units.

In another embodiment, the method can include a plurality of remote computer stations such that the information displayed on the local display unit can be displayed on the remote display unit of at least one of the plurality of remote computer stations. Optionally, at least one of the plurality of remote computer stations can be selected.

The present invention also comprises a system for monitoring an image displayed on a local display unit at a remote computer station. The system comprises a network and a device connected to the network. The network conveys the formed data. The device forms data related to the information displayed on the local display unit into a data transfer protocol format (e.g., IP), and transmits the formed data through the network. Typically, the device captures the data related to the information displayed on the local display unit. Optionally, the device compresses the data. Optionally, the device encrypts the data. Optionally, the device responds to a signal from the remote computer station. Optionally, the device prevents transmission of the formed data through the network.

The remote computer station receives the formed data, converts it to visual display (pixel) format (e.g., DVI), and displays the converted data on a remote display unit of the remote computer station. Typically, the remote computer station stores the converted data in a frame buffer. Optionally, the remote computer station decrypts the converted data. Optionally, the remote computer station decompresses the converted data.

The local display unit can be a component of a local computer station, a digital camera, a digital video camera, an endoscope, etc.

The device can comprise a computer usable medium having computer readable program code means embodied in the computer usable medium for causing an application program to execute on a controller. Alternatively, the device can comprise an interface card or a connector.

The present invention also comprises a computer program product for monitoring information displayed on a local display unit at a remote computer station. The computer program product comprises a computer usable medium having computer readable program code means embodied in the computer usable medium for causing an application program to execute on a controller that controls the local display unit. The computer readable program code means comprises a computer readable first program code means for causing a controller to form data related to the information displayed on the local display unit into a data transfer protocol format (e.g., IP), and a computer readable second program code means for causing the controller to transmit the formed data through a network to the remote computer station.

Typically, the computer readable program code means can further comprise a computer readable third program code means for causing the controller to capture the data related to the information displayed on the local display unit. Optionally, the third program code means can cause the controller to compress the data. Optionally, the third program code means can cause the controller to encrypt the data.

In an embodiment, the remote computer station can selectively monitor information displayed on the local display unit. In this case, the computer usable medium can further comprise a computer readable third program code means for causing the controller to respond to a signal from the remote computer station. Optionally, the computer usable medium can further comprise a computer readable fourth program code means for causing the controller to prevent transmission of the formed data through the network.

The present invention also comprises an interface card for enabling monitoring information displayed on a local display unit at a remote computer station. The interface card comprises an integrated circuit. The integrated circuit can be an application specific integrated circuit, a field programmable gate array, etc. The integrated circuit comprises a first logic circuit for forming data related to the information displayed on the local display unit into a data transfer protocol format (e.g., IP), and a second logic circuit for transmitting the formed data through a network to the remote computer station.

Typically, the integrated circuit can further comprise a third logic circuit for capturing the data related to the information displayed on the local display unit. Optionally, the third logic circuit can compress the data. Optionally, the third logic circuit can encrypt the data.

In an embodiment, the remote computer station can selectively monitor information displayed on the local display unit. In this case, the integrated circuit can further comprise a third logic circuit for responding to a signal from the remote computer station. Optionally, the integrated circuit can further comprise a fourth logic circuit for preventing transmission of the formed data through the network.

The present invention also comprises a connector for enabling monitoring information displayed on a local display unit at a remote computer station. In one embodiment, the connector comprises a port for connecting the connector to a network, an inductive signal clamp for connecting to a visual display link of the local display unit, and an integrated circuit. The integrated circuit comprises a first logic circuit for capturing data related to the information displayed on the local display unit, a second logic circuit for forming said captured data into a data transfer protocol (e.g., IP), a third logic circuit for interfacing between the second logic circuit and the network, and a fourth logic circuit for transmitting said formed data through the network to the remote computer station.

In another embodiment, the connector comprises a first port for connecting the connector to a network, a second port for connecting the connector to the local display unit, and an integrated circuit. The integrated circuit comprises a first logic circuit for forming data related to the information displayed on the local display unit into a data transfer protocol (e.g., IP), a second logic circuit for interfacing between the first logic circuit and the network, and a third logic circuit for transmitting said formed data through the network to the remote computer station. Typically, the integrated circuit can further comprise a fourth logic circuit for capturing the data related to the information displayed on the local display unit. Optionally, the connector can further comprise a third port for connecting the connector to a local computer station. The connector can be a DVI connector.

In either embodiment, the integrated circuit can be an application specific integrated circuit, a field programmable gate array, etc. Optionally, in either embodiment, the integrated circuit can further comprise another logic circuit for compressing the data related to the information displayed on the local display unit. Optionally, in either embodiment, the integrated circuit can further comprise another logic circuit for encrypting the data related to the information displayed on the local display unit. Optionally, in either embodiment, the remote computer station can selectively monitor information displayed on the local display unit. In this case, the integrated circuit can further comprise another logic circuit for responding to a signal from the remote computer station. Optionally, the integrated circuit can further comprise yet another logic circuit for preventing transmission of the formed data through the network.

An advantage of the present invention is that it leverages the proliferation of visual display formats used to convey pixel data between a graphics controller in a computer of a local computer station and a display controller in a display unit of the local computer station. A monitoring system includes devices that can capture, encrypt, compress, convert, and transmit the pixel data in a data transfer protocol format (e.g., IP) from the local computer station to a remote computer station. The monitoring system can make use of a preexisting network so that the monitoring system can be implemented inexpensively and with minimal burden. A device is also provided that enables a network, having components with compatible visual display formats, to be configured to act as a monitoring system.

### BRIEF DESCRIPTION OF THE FIGURES

The accompanying drawings, which are incorporated herein and form part of the specification, illustrate the present invention and, together with the description, further serve to explain the principles of the invention and to enable a person skilled in the pertinent art to make and use the invention.

FIG. 1 shows a monitoring system configured in the manner of the present invention.

FIG. 2 highlights how the present invention interacts with a digital video link, such as Digital Video Interface.

FIG. 3 depicts an exemplary network configured as a monitoring system in the manner of the present invention.

FIG. 4 shows a high level representation of a monitoring system with a plurality of local display units.

FIG. 5 shows a flow chart of a method for monitoring information displayed on a local display unit at a remote computer station.

The preferred embodiments of the invention are described with reference to the figures where like reference numbers indicate identical or functionally similar elements. Also in the figures, the left-most digit of each reference number identify the figure in which the reference number is first used.

### DETAILED DESCRIPTION OF THE INVENTION

Table of Contents
Overview
Terminology
Monitoring System
Method
System
Computer Program Product
Interface Card
Connectors
Conclusion
   Overview

The present invention relates to devices for monitoring digital video signals and associated monitoring methods and systems. The present invention uses network technology and a digital display interface (e.g., Digital Visual Interface Transition Minimized Differential Signaling (DVI TMDS)) to produce a monitoring system. Where a network connects a local computer station to a remote computer station, and a computer of the local computer station transmits data in a visual display (pixel) format to a display unit of the local computer station, the present invention provides a device that can form the data into a data transfer protocol format (e.g., Internet Protocol (IP)) and transmit the formed data through the network to the remote computer station for display on a display unit of the remote computer station. Thus, the present invention enables the remote computer station to monitor information displayed on the local display unit at the remote computer station. The local display unit can be a component of the local computer station, a digital camera, a digital video camera, an endoscope, etc. The device of the present invention can be realized as software, hardware (e.g., an interface card), a connector, or some combination of these.

Terminology

The term “display interface” refers to any type of interface between a graphics controller and a display unit. One example display interface is a Digital Visual Interface (DVI). This example is illustrative. Other types of display interfaces can be used in the present invention.

The term “video link” refers to any link carrying pixel data and control data over a display interface between a graphics controller and a display unit. One example video link is a Transition Minimized Differential Signaling (TMDS) link. This example is illustrative. Other types of video links can be used in the present invention.

Monitoring System

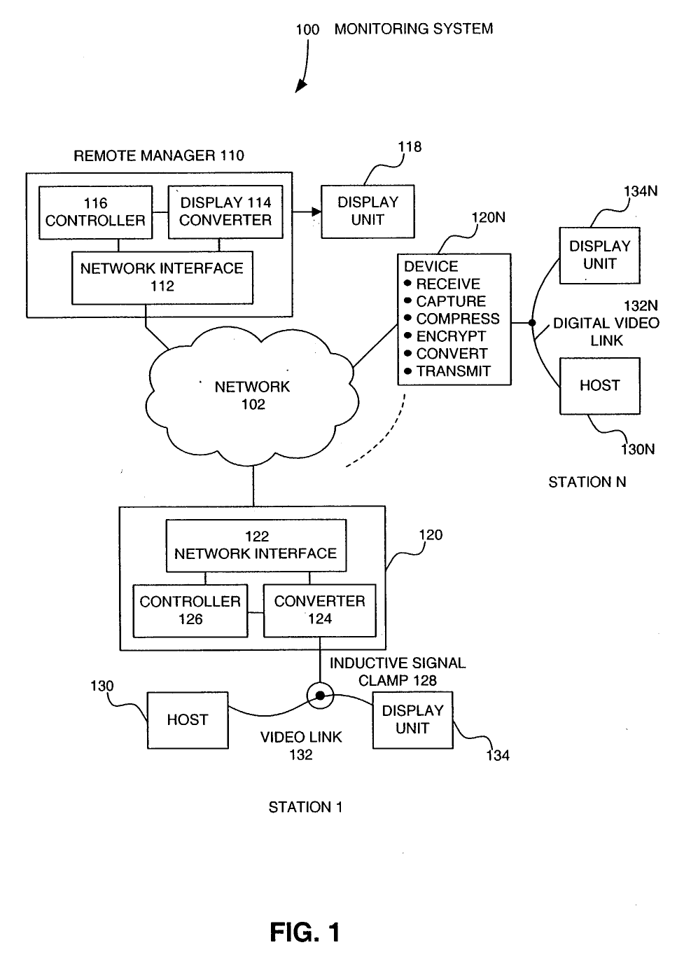

FIG. 1 shows a monitoring system 100 configured in the manner of the present invention. Monitoring system 100 comprises a network 102, a remote manager 110, and several stations to be monitored including station 1 through station N. Remote manager 110 comprises a network interface 112, a display converter 114, a controller 116, and a display unit 118. Controller 116 manages the functions of network interface 112 and display converter 114. Optionally, controller 116 can produce a signal requesting data from one or more of stations 1 through N. Network interface 112 can transmit the signal. Network interface 112 can also receive data from one or more of stations 1 through N and transmit them to display converter 114. Data received by network interface 112 is in a data transfer protocol format, such as, but not limited to, IP. Display converter 114 converts the received data to a visual display format, such as, but not limited to, DVI. Optionally, display converter 114 can decrypt the received data after converting it, if the received data was encrypted. Optionally, display converter 114 can decompress the received data after converting it, if the received data was compressed. If the received data is to be decrypted and decompressed, the data is decrypted before it is decompressed. Display unit 118 displays the converted data. Optionally, display unit stores the converted data in a frame buffer (not shown).

Each station to be monitored comprises a device 120, a host 130, a video link 132, and a display unit 134. Host 130 is coupled to display unit 134 via video link 132. Device 120 comprises a network interface 122, a converter 124, and a controller 126. Controller 126 manages the functions of network interface 122 and converter 124. An inductive signal clamp 128 can be used by device 120 to capture data sent from host 130 to display unit 134 via video link 132. Data captured by inductive signal clamp 128 is in a visual display format, such as, but not limited to, DVI. Converter 124 forms the captured data into a data transfer protocol format, such as, but not limited to, Internet Protocol. Optionally, converter 124 can compress the received data prior to converting it. Optionally, converter 124 can encrypt the received data prior to converting it. If the received data is to be compressed and encrypted, the data is compressed before it is encrypted. Network interface 122 receives data formed by converter 124 and transmits the data to network 102. Network 102 conveys the formed data. Optionally, network interface 122 can receive a signal from remote manager 110 requesting data. Controller 126 can respond to the signal. Optionally, controller 126 can prevent transmission of the formed data.

Alternatively, monitoring system 100 can comprise additional remote managers (not shown) such that formed data transmitted through network 102 from a station can be received by network interface 112 of one or more remote managers. For each remote manager that receives formed data, network interface 112 can transmit the formed data to display converter 114. Each display converter 114 can convert the received data to a visual display format. Each display unit 118 can display the converted data. Where monitoring system includes more than one remote manager, one or more of the remote managers can be selected.

Increasingly, individual display units, such as flat panel monitors, use display interfaces to connect to display driving hardware located in associated computers. In one example, pixel data and control data are sent over the display interface from a graphics controller at the computer to a display controller at the display unit. One or more video links carry the pixel data and control data between the graphics controller and the display controller.

One open standard currently being promulgated is the DVI specification available from the Digital Display Working Group (DDWG). See, Digital Visual Interface (DVI) specification, Revision 1.0, pages 1-76, Apr. 2, 1999, incorporated herein in its entirety. DVI is particularly directed to providing a connection between a computer and its display unit, and to managing compatibility in an era of transition from analog to digital video formats. DVI fosters compatibility through use of the Transition Minimized Differential Signaling (TMDS) protocol. Data from a graphics controller is converted to TMDS format by a TMDS transmitter. The data is transmitted to the display unit via a type of video links, referred to as TMDS links. At the display unit, the data is received by a TMDS receiver. The TMDS receiver converts the data to a format for use by a display controller.

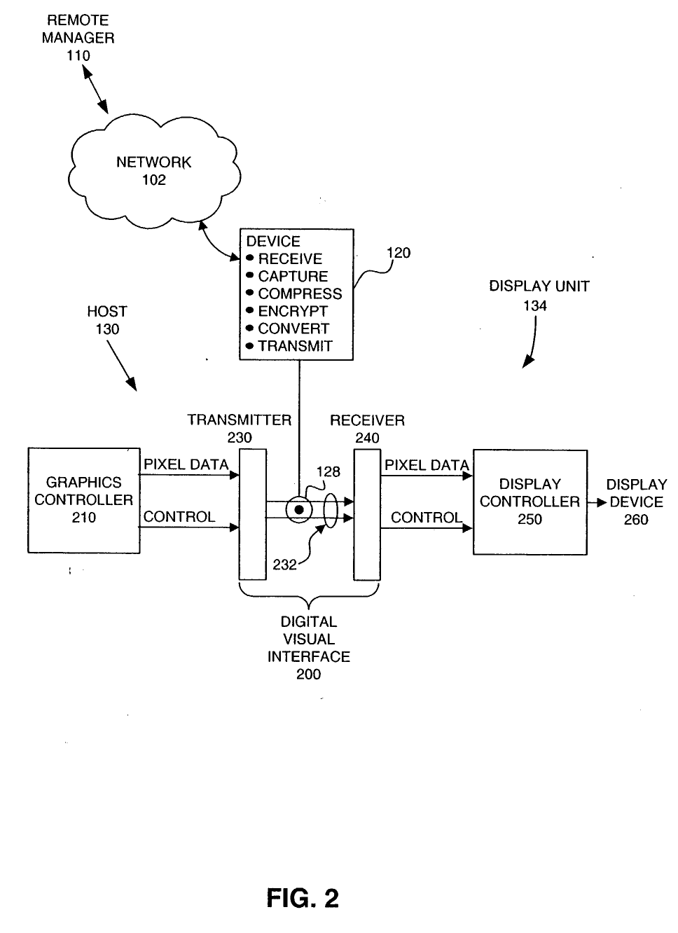

FIG. 2 highlights how the present invention interacts with a video link, such as DVI 200. As explained above, DVI 200 employs a transmitter 230, TMDS links 232, and a receiver 240 to transmit pixel data and control data from a graphics controller 210 in host 130 to a display controller 250 in display unit 134. Display controller 250 transmits the data to a display device 260.

DVI recognizes that graphics data produced by graphics controller 210 and consumed by display controller 250 can have different formats depending upon a variety of parameters encompassed within the technologies employed in each component. Such variations, which include pixel formats, timing schemes, and bandwidth, can also vary by vendor. To foster compatibility, DVI imposes the TMDS protocol for transferring data from graphics controller 210 to display controller 250. Recognizing TMDS as the “least common denominator”, inductive signal clamp 128 of the present invention is positioned to capture data between transmitter 230 and receiver 240 so that the data is in a format that can be read at remote manager 110.

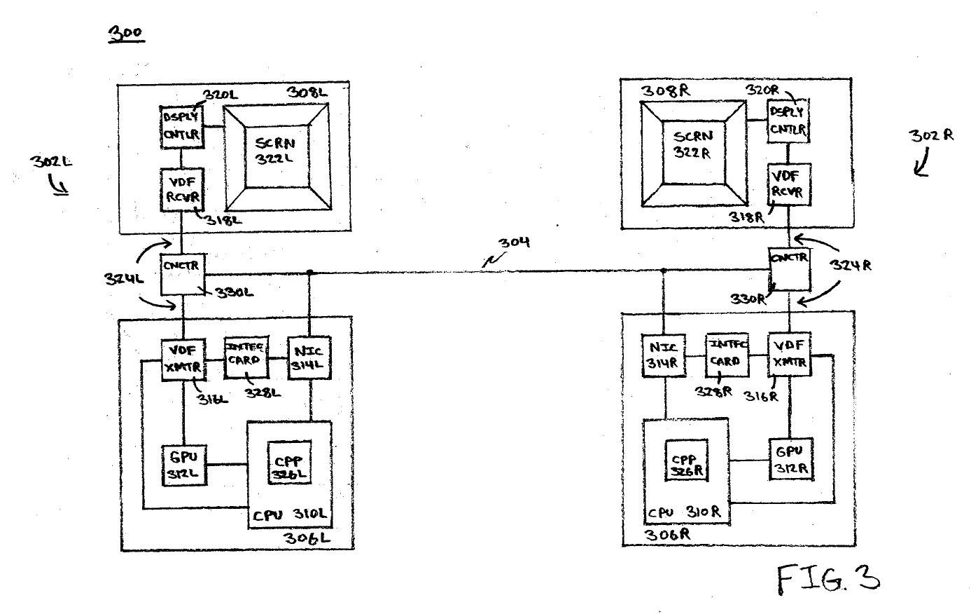

FIG. 3 depicts an exemplary network 304 configured as a monitoring system 300 in the manner of the present invention. System 300 comprises a local computer station 302L and a remote computer station 302R. (System 300 could further comprise other stations. However, for ease of explanation only local computer station 302L and remote computer station 302R are described.) Local and remote computer stations 302L, 302R are connected together via a network 304. It will be recognized that network 304 can also include additional computer stations or other electronic products, and that some or all of these can be included in system 300.

Network 304 comprises standard network technology. Preferably, but not by way of limitation, this includes network interface hardware, such as Ethernet, using a standard data transfer protocol, such as Internet Protocol (IP). Often, network 304 is managed by a server (not shown). In network 304, the connection between local and remote computer stations 302L, 302R can be realized by data lines, telephone lines, wireless technologies, or other means that will be recognized by those skilled in the art.

Each of local and remote computer stations 302L, 302R comprises a computer 306L, 306R and a display unit 308L, 308R. Each computer 306L, 306R includes a central processing unit (CPU) 310L, 310R; a graphics processing unit (GPU) 312L, 312R; a network interface card (NIC) 314L, 314R; and a visual display format transmitter (VDF XMTR) 316L, 316R. Each display unit 308L, 308R includes a visual display format receiver (VDF RCVR) 318L, 318R; a display controller (DSPLY CNTLR) 320L, 320R; and a display screen (SCRN) 322L, 322R. (Alternatively, display unit 308L can be a digital camera, a digital video camera, an endoscope, etc.) Visual display format (e.g., DVI) links 324L, 324R connect each computer 306L, 306R with its display unit 308L, 308R. Optionally, visual display links 324L, 324R can attach to computer 306L, 306R and display unit 308L, 308R via connectors (not shown).

The device of the present invention can be realized in several different forms: computer program products (CPP) 326L, 326R; interface cards (INTFC CARD) 328L, 328R; or connectors (CNCTR) 330L, 330R. Each CPP 326L, 326R comprises a computer usable medium having computer readable program code means embodied in the computer usable medium for causing an application program to execute on a controller.

When CPU 310L of computer 306L executes instructions to display information on SCRN 322L of display unit 308L, CPU 310L can transfer some or all of the calculations needed to produce the information to be displayed to GPU 312L in a manner well known within the art. Data related to the information to be displayed is produced by CPU 310L, GPU 312L, or both. This data, which includes both pixel formatting data and display unit control data, is sent to VDF XMTR 316L. VDF XMTR 316L converts this data to a visual display (pixel) format (e.g., DVI) and transmits this data to VDF RCVR 318L of display unit 308L via visual display links 324L. VDF RCVR 318L converts this data to a format for use by DSPLY CNTLR 320L. DSPLY CNTLR 320L transfers the pixel formatting data to the appropriate pixels of memory (e.g., a frame buffer) of SCRN 322L, and uses the display unit control data to control presentation of the information on SCRN 322L.

In an embodiment of system 300, computer station 302R continuously or selectively monitors information displayed on SCRN 322L of computer station 302L. When monitoring this displayed information, computer station 302R receives the data transmitted from computer 306L to display unit 308L. This data is transferred across network 304 to computer station 302R from computer station 302L by a device of the present invention (e.g., CPP 326L, INTFC CARD 328L, or CNCTR 330L). If computer station 302R selectively monitors information displayed on SCRN 322L, then the device of the present invention transfers this data in response to a signal received at computer station 302L from computer station 302R via network 304.

CPP 326L, INTFC CARD 328L, or CNCTR 330L converts the data from the visual display (pixel) format (e.g., DVI) to a data transfer protocol format used by network 304 (e.g., IP). Where the device of the present invention is realized as CNCTR 330L, it captures the data in visual display (pixel) format as it is being transmitted from VDF XMTR 316L to VDF RCVR 318L. Optionally, CPP 326L, INTFC CARD 328L, or CNCTR 330L compresses the data using a standard compression scheme. Optionally, CPP 326L, INTFC CARD 328L, or CNCTR 330L encrypts the data. Where the device of the present invention is realized as CPP 326L or INTFC CARD 328L, the data is sent to NIC 314L, which transmits the data to the network. Where the device of the present invention is realized as CNCTR 330L, the functions of NIC 314L can be incorporated into CNCTR 330L. Also, where the device of the present invention is realized as CNCTR 330L, the function of CPU 310L or DSPLY CNTLR 320L can be incorporated into CNCTR 330L. Particularly, this can be the case where computer station 302L or display unit 308L is replaced by another electronic product such as, but not limited to, a digital camera, a digital video camera, an endoscope, etc.

The data is received by NIC 314R at computer station 302R. NIC 314R sends the data to CPU 310R of computer 306R. CPU 310R executes instructions to display the information on SCRN 322R of display unit 308R. As with CPU 310L, CPU 310R can transfer some or all of the calculations needed to produce the information to be displayed to GPU 312R in a manner well known within the art. Data related to the information to be displayed is produced by CPU 310R, GPU312R, or both. This data is sent to VDF XMTR 316R. VDF XMTR 316R converts this data to the visual display (pixel) format and transmits the data to VDF RCVR 318R of display unit 308R via visual display links 324R. VDF RCVR 318R converts this data to a format for use by DSPLY CNTLR 320R. DSPLY CNTLR 320R transfers the pixel formatting data to the appropriate pixels of memory (e.g., a frame buffer) of SCRN 322R, and uses the display unit control data to control presentation of the information on SCRN 322R.

Thus, the information displayed on SCRN 322L is also displayed on SCRN 322R so that the information at computer station 302L can be monitored at computer station 302R.

If the visual display (pixel) format used is DVI, then it is preferable that the graphics capabilities of computer station 302R be comparable or superior to the graphics capabilities of computer station 302L. This is because DVI uses the Extended Display Identification Data (EDID) standard to verify the graphics capabilities of both computer 306L, 306R and display unit 308L, 308R so that VDF XMTR 316L, 316R can know the specific TMDS format into which to convert the data related to the information to be displayed.

Where system 300 comprises a plurality of local display units 308L, remote computer station 302R can be configured to select which one of the plurality of local display units 308L to display on SCRN 322R. Alternatively, SCRN 322R can be tiled into a plurality of tile portions such that a tile portion of the plurality of tile portions can display one of the plurality of local display units 308L. Means for tiling graphics on a monitor screen are described, among other places, in co-assigned application Ser. No. 09/689,784 for Sadowski et al., entitled “Method and System for Minimizing an Amount of Data Needed to Communicate Tile Information in Spatially Composited Digital Video”, now pending, which is incorporated herein by reference.

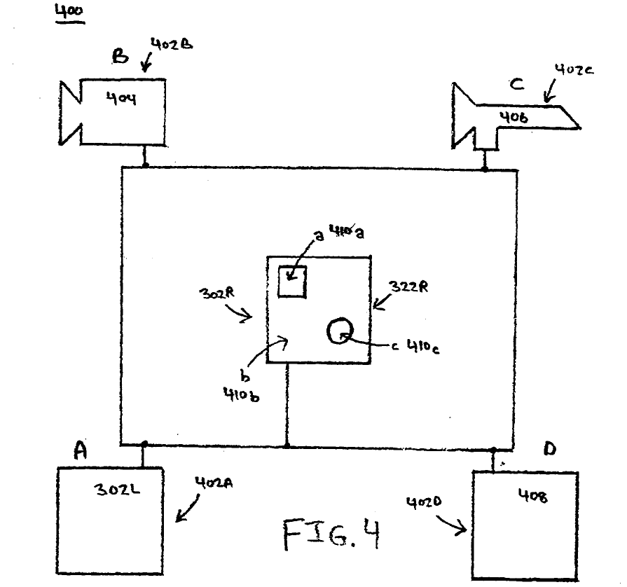

For example, FIG. 4 shows a high level representation 400 of monitoring system 300 with a plurality of local display units: A 402A, B 402B, C 402C, and D 402D. The skilled artisan will understand that monitor system 300 can include more or fewer local display units. In high level representation 400, local display units A 402A, B 402B, C 402C, and D 402D are connected to remote computer station 302R by network 304 as described above. Local display unit A 402A can be, for example, first local computer station 302L; local display unit B 402B can be, for example, a digital video camera 404; local display unit C 402C can be, for example, an endoscope 406; and local display unit D 402D can be, for example, a second local computer station 408.

Each of local display units 402A, 402B, 402C, and 402D includes a device of the present invention (e.g., CPPs 326L, INTFC CARDs 328L, or CNCTRs 330L), which converts the data related to the information to be displayed to a data transfer protocol format (e.g., IP) and transmits this data to computer station 302R via network 304. The data is received by NIC 314R at computer station 302R. NIC 314R sends the data to CPU 310R of computer 306R. CPU 310R executes instructions to display the information on SCRN 322R of display unit 308R.

The instructions to display the information on SCRN 322R can include instructions to tile SCRN 322R into a plurality of tile portions: a 410a, b 410b, and c 410c. The skilled artisan will understand that SCRN 322R can be tiled into more or fewer tile portions. The size, shape, and position of each tile portion on SCRN 322R can be controlled by computer station 302R in a manner well known within the art. Tile portion a 410a can be, for example, a square in an upper left corner of SCRN 322R; tile portion c 410c can be, for example, a circle in a lower right corner of SCRN 322R; and tile portion b 410b can be, for example, the remaining portions of SCRN 322R.

Likewise, computer station 302R can dedicate tile portions a 410a, b 410b, and c 410c to displaying information from some of the local display units. For example, tile portion a 410a can be dedicated to displaying information from local display unit A 402A, tile portion b 410b can be dedicated to displaying information from local display unit B 402B, and tile portion c 410c can be dedicated to displaying information from local display unit C 402C. Such an arrangement might be used, for example, where monitoring system 300 is used to observe a patient undergoing an operation (with the information from digital video camera 404 displayed at tile portion b 410b), an internal procedure of the operation (with the information from endoscope 406 displayed at tile portion c 410c), and data related to the functioning of various organs of the patient (with the information from first local computer station 302L displayed at tile portion a 410a).

The number of local display units 402 and tile portions 410 are independent of one another. A local display unit 402 can be displayed at more than one tile portion 410 or none of them. Thus, the present invention allows monitoring system 300 to have innumerable configurations to support a wide variety of applications.

Method

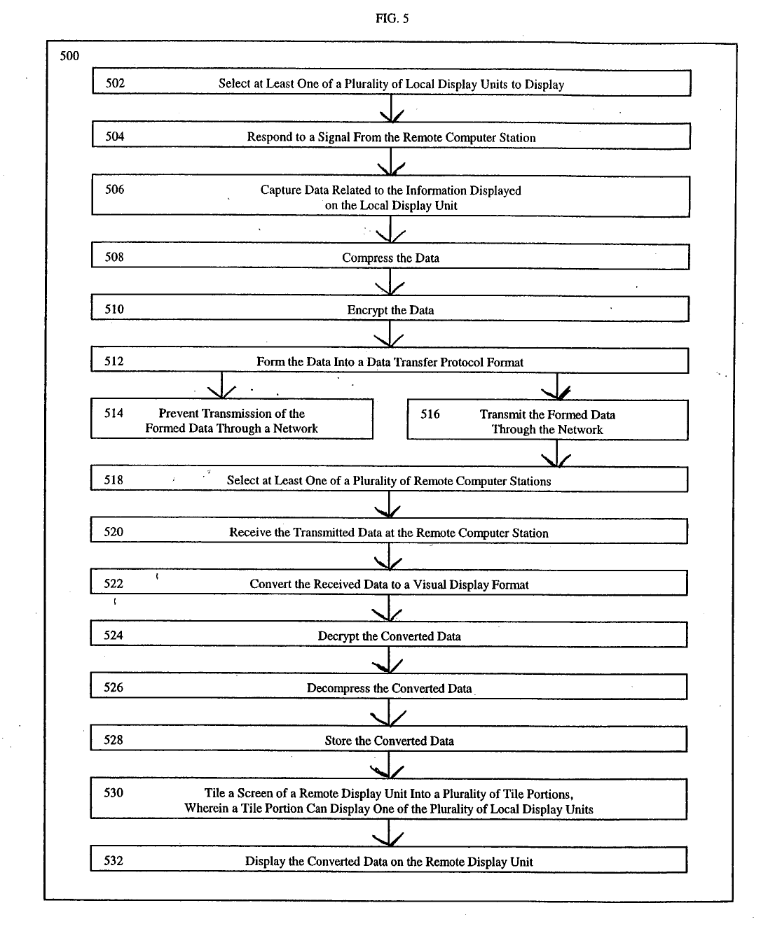

FIG. 5 shows a flow chart of a method 500 for monitoring information displayed on a local display unit at a remote computer station. If a monitoring system includes a plurality of local display units, then method 500 can start at a step 502. At step 502, at least one of the plurality of local display units is selected to be displayed at the remote computer station. If the remote computer station can selectively (i.e., as opposed to continuously) monitor information displayed on the local display unit, then method 500 can proceed to at a step 504. At step 504, a controller that controls the local display unit responds to a signal from the remote computer station. If the monitoring system is not configured automatically to transmit data related to the information displayed on the local display unit directly to a network for monitoring, then method 500 can proceed to a step 506. At step 506, data related to the information displayed on the local display unit is captured. Optionally, at a step 508, the data is compressed. Optionally, at a step 510, the data is encrypted.

At a step 512, the data is formed into a data transfer protocol (e.g., IP). If the local display unit has override capability, then method 500 can proceed to a step 514. At step 514, transmission of the formed data through the network is prevented. Alternatively, method 500 can proceed to a step 516. At step 516, the formed data is transmitted through the network.

If the monitoring system includes a plurality of remote computer stations, then method 500 can proceed to a step 518. At step 518, at least one of the plurality of remote computer stations is selected to receive the transmitted data. At a step 520, the transmitted data is received at the remote computer station. At a step 522, the received data is converted to a visual display format (e.g., DVI). If the converted data was encrypted, at a step 524, the converted data is decrypted. If the converted data was compressed, at a step 526, the converted data is decompressed. Optionally, at a step 528, the converted data is stored.

If the remote computer station is configured to monitor more than one local display unit at the same time, then method 500 can proceed to a step 530. At step 530, a screen of a remote display unit of the remote computer station is tiled into a plurality of tile portions, wherein a tile portion can display one of the plurality of local display units. At a step 532, the converted data is displayed on the remote display unit, thereby monitoring information displayed on the local display unit at the remote computer station.

System

The present invention comprises system 300 for monitoring information displayed on a local display unit 308L at a remote computer station 302R. Monitoring system 300 comprises a network 304 and a device (e.g., CPP 326L, INTFC CARD 328L, or CNCTR 330L) connected to network 304. The device forms data related to the information displayed local display unit 308L into a data transfer protocol format (e.g. IP), and transmits the formed data through network 304. Network 304 conveys the formed data. Remote computer station 302R receives the formed data, converts the formed data to a visual display format (e.g., DVI), and displays the converted data on a remote display unit 308R. Optionally, remote computer station 302R can store the converted data in a frame buffer (not shown).

The device can comprise a computer usable medium having computer readable program code means embodied in the computer usable medium for causing an application program to execute on the controller (e.g., CPP 326L). Alternatively, the device can comprise an interface card (e.g., INTFC CARD 328L) or a connector (e.g., CNCTR 330L).

Where the device of the present invention is realized as CNCTR 330L, it captures the data related to the information displayed on local display unit 308L. Typically, this is done when the data is being transmitted in visual display (pixel) format from VDF XMTR 316L to VDF RCVR 318L. Optionally, CPP 326L, INTFC CARD 328L, or CNCTR 330L compresses the data using a standard compression scheme. Remote computer station 302R can decompress the data remote computer station 302R receives after converting the data to a visual display (pixel) format. Optionally, CPP 326L, INTFC CARD 328L, or CNCTR 330L encrypts the data. Remote computer station 302R can decrypt the data remote computer station 302R receives after converting the data to a visual display (pixel) format.

If computer station 302R selectively monitors information displayed on SCRN 322L, then the device of the present invention can transfer this data in response to a signal received at the device from remote computer station 302R via network 304. Optionally, if the device has override capability, it can prevent transmission of the formed data through network 304.

In one embodiment, local display unit 308L can be a component of local computer station 302L. Alternatively, local display unit 308L can be a digital camera, a digital video camera, an endoscope, etc.

Monitoring system 300 is flexible in its configuration. Where monitoring system 300 includes more than one computer station 302, any of them can be designated as remote computer station 302R. Thus, monitoring can readily be shifted from one computer station 302 to another. For this same reason, data related to the information displayed on local display unit 308L can be encrypted so that the data is monitored only at the designated remote computer station 302R. Also, where remote computer station 302R has a device of the present invention (e.g., CPP 326R, INTFC CARD 328R, or CNCTR 330R), remote computer station 302R can be transformed into a local computer station 302L so that local display unit 308L can be monitored by another computer station 302.

Additionally, network 300 of monitoring system 300 can be either a preexisting network used for other data transfers or an autonomous network dedicated for use by monitoring system 300. Remote computer station 302R can monitor local display units 308L continuously or selectively. Likewise, local display unit 308L can be configured to transmit data related to the information displayed continuously or only if selected. Furthermore, local display unit 308L can be configured selectively to prevent the transmission of data related to the information displayed.

Computer Program Product

The device of the present invention can be realized as a computer program product (e.g., CPP 326L) for enabling monitoring of information displayed on a local display unit (e.g., local display unit 308L) at a remote computer station (e.g., remote computer station 302R). CPP 326L comprises a computer usable medium having computer readable program code means embodied in the computer usable medium for causing an application program to execute on a controller (e.g., CPU 310L, DSPLY CNTLR 320L) that controls local display 308L. The computer readable program code means comprises a computer readable first program code means for causing the controller to form data related to the information displayed on the local display unit into a data transfer protocol (e.g., IP), and a computer readable second program code means for causing the controller to transmit the formed data through a network (e.g., network 304) to the remote computer station.

If the monitoring system is not configured automatically to transmit data related to the information displayed on the local display unit directly to a network for monitoring, then CPP 326L can further comprise a computer readable third program code means for causing the controller to capture the data related to the information displayed on the local display unit. Optionally, the third program code means can cause the controller to compress the data. Optionally, the third program code means can cause the controller to encrypt the data.

In an embodiment, the remote computer station can selectively monitor information displayed on the local display unit. In this case, CPP 326L can further comprise a computer readable third program code means for causing the controller to respond to a signal from the remote computer station. Optionally, CPP 326L can further comprise a computer readable fourth program code means for causing the controller to prevent transmission of the formed data through the network.

Advantageously, CPP 326L can readily enable a local display unit 402 to be used in monitoring system 300 without requiring additional hardware.

Interface Card

The device of the present invention can be realized as an interface card (e.g., INTFC CARD 328L) for enabling monitoring of information displayed on a local display unit (e.g., local display unit 308L) at a remote computer station (e.g., remote computer station 302R). INTFC CARD 328L comprises an integrated circuit. The integrated circuit comprises a first logic circuit for forming data related to the information displayed on the local display unit into a data transfer protocol format (e.g., IP), and a second logic circuit for transmitting the formed data through a network (e.g., network 304) to the remote computer station.

If the monitoring system is not configured automatically to transmit data related to the information displayed on the local display unit directly to a network for monitoring, then INTFC CARD 328L can further comprise a third logic circuit for capturing the data related to the information displayed on the local display unit. Optionally, the third logic circuit can compress the data. Optionally, the third logic circuit can encrypt the data.

In an embodiment, the remote computer station can selectively monitor information displayed on the local display unit. In this case, INTFC CARD 328L can further comprise a third logic circuit that can respond to a signal from the remote computer station. Optionally, INTFC CARD 328L can further comprise a fourth logic circuit that can prevent transmission of the formed data through the network.

Preferably, INTFC CARD 328L is a Personal Memory Card International Association (PCMCIA)-standard interface card. The integrated circuit of INTFC CARD 328L can comprise an application specific integrated circuit (ASIC), a field programmable gate array (FPGA), etc.

Advantageously, in comparison with CPP 326L, INTFC CARD 328L can improve the processing speed of monitoring system 300. Also, in comparison with CPP 326L, INTFC CARD 328L limits the use of CPU 310L by monitoring system 300, such that servicing of other software applications by CPU 310L is not hindered.

Connectors

The device of the present invention can be realized as a connector (e.g., CNCTR 330L) for enabling monitoring of information displayed on a local display unit (e.g., local display unit 308L) at a remote computer station (e.g., remote computer station 302R). In one embodiment, CNCTR 330L comprises a port for connecting CNCTR 330L to a network (e.g., network 304), an inductive signal clamp for connecting to a visual display link (e.g., visual display link 324L) of the local display unit, and an integrated circuit. Via induction, the inductive signal clamp is able to capture visual display format (pixel) signals transiting through the visual display link. The integrated circuit comprises a first logic circuit for capturing data related to the information displayed on the local display unit, a second logic circuit for forming said captured data into a data transfer protocol (e.g. IP), a third logic circuit for interfacing between the second logic circuit and the network, and a fourth logic circuit for transmitting said formed data through the network to the remote computer station.

In another embodiment, CNCTR 330L comprises a first port for connecting CNCTR 330L to the network, a second port for CNCTR 330L to the local display unit, and an integrated circuit. The integrated circuit comprises a first logic circuit for forming data related to the information displayed on the local display unit into a data transfer protocol (e.g., IP), a second logic circuit for interfacing between the first logic circuit and the network, and a third logic circuit for transmitting said formed data through the network to the remote computer station. Typically, the integrated circuit can further comprise a fourth logic circuit for capturing the data related to the information displayed on the local display unit. Optionally, CNCTR 330L can further comprise a third port for connecting CNCTR 330L to a local computer station (as when local display unit 308L is a component of local computer station 302L). CNCTR 330L can be a DVI connector.

In either embodiment, the integrated circuit can be an application specific integrated circuit, a field programmable gate array, etc. Optionally, in either embodiment, the integrated circuit can further comprise another logic circuit for compressing the data related to the information displayed on the local display unit. Optionally, in either embodiment, the integrated circuit can further comprise another logic circuit for encrypting the data related to the information displayed on the local display unit. Optionally, in either embodiment, the remote computer station can selectively monitor information displayed on the local display unit. In this case, the integrated circuit can further comprise another logic circuit for responding to a signal from the remote computer station. Optionally, the integrated circuit can further comprise yet another logic circuit for preventing transmission of the formed data through the network.

Where local display unit 308L is another electronic product such as, but not limited to, a digital camera, a digital video camera, or an endoscope, etc., CNCTR 330L can further comprise a controller (e.g., to perform the function of CPU 310L or DSPLY CNTLR 320L).

Advantageously, CNCTR 330L can allow monitoring system 300 to support local display units that are not configured automatically to transmit data related to the information displayed on the local display unit directly to a network.

### CONCLUSION

While various embodiments of the present invention have been described above, it should be understood that they have been presented by way of example, and not limitation. It will be apparent to persons skilled in the relevant art that various changes in form and detail can be made therein without departing from the spirit and scope of the invention. Thus the present invention should not be limited by any of the above-described exemplary embodiments, but should be defined only in accordance with the following claims and their equivalents.

1. A method for monitoring information displayed on a local display unit at a remote computer station, comprising the steps of:
(1) forming data related to the information displayed on the local display unit into a data transfer protocol format;
(2) transmitting said formed data through a network;
(3) receiving said transmitted data at the remote computer station;
(4) converting said received data to a visual display format; and
(5) displaying said converted data on a remote display unit of the remote computer station, thereby monitoring information displayed on the local display unit at the remote computer station.

2. The method of claim 1, further comprising, before said step (1), the step of:
(6) capturing the data related to the information displayed on the local display unit.

3. The method of claim 2, wherein said captured information is in a second visual display format.

4. The method of claim 3, wherein the second visual display format is a Digital Visual Interface Transition Minimized Differential Signaling format.

5. The method of claim 1, wherein the visual display format is a Digital Visual Interface Transition Minimized Differential Signaling format, and said step (4) comprises the step of:
converting said received data to the Digital Visual Interface Transition Minimized Differential Signaling format.

6. The method of claim 1, further comprising, the steps of:
(6) before said step (1), compressing the data related to the information displayed on the local display unit; and
(7) after said step (4), decompressing said converted data at the remote computer station.

7. The method of claim 1, further comprising, the steps of:
(6) before said step (1), encrypting the data related to the information displayed on the local display unit; and
(7) after said step (4), decrypting said converted data at the remote computer station.

8. The method of claim 1, further comprising, before said step (1), the step of:
(6) responding to a signal from the remote computer station.

9. The method of claim 8, further comprising the step of:
(7) preventing transmission of said formed data through the network.

10. The method of claim 1, further comprising, before said step (5), the step of:
(6) storing said converted data in a frame buffer of the remote computer station.

11. The method of claim 1, wherein the local display unit is one of a plurality of local display units, and further comprising the step of:
(6) repeating said step (1) through said step (2) for at least one other of the plurality of local display units.

12. The method of claim 11, wherein said step (5) comprises the step of:
displaying said converted data of at least one of the plurality of local display units on the remote display unit of the remote computer station, thereby monitoring information displayed on at least one of the plurality of local display units at the remote computer station.

13. The method of claim 12, further comprising the step of:
(7) selecting at least one of the plurality of local display units to display.

14. The method of claim 12, further comprising the step of:
(7) tiling a screen of the remote display unit into a plurality of tile portions, wherein a tile portion of the plurality of tile portions can display one of the plurality of local display units.

15. The method of claim 1, wherein the remote computer station is one of a plurality of remote computer stations, and further comprising the step of:
(6) repeating said step (3) through said step (5) at at least one other of the plurality of remote computer stations.

16. The method of claim 15, wherein said step (5) comprises the step of:
displaying said converted data on the remote display unit of at least one of the plurality of remote computer stations, thereby monitoring information displayed on the local display unit at at least one of the plurality of remote computer stations.

17. The method of claim 16, further comprising the step of:
(7) selecting at least one of the plurality of remote computer stations.

18. A system for monitoring information displayed on a local display unit at a remote computer station, comprising:
a network; and
a device connected to said network;
wherein:
said device forms data related to the information displayed on the local display unit into a data transfer protocol format, and transmits said formed data through said network;
said network conveys said formed data; and
the remote computer station receives said formed data, converts said formed data to a visual display format, and displays said converted data on a remote display unit of the remote computer station.

19. The system of claim 18, wherein said device captures said data related to the information displayed on the local display unit.

20. The system of claim 18, wherein said device compresses said data related to the information displayed on the local display unit.

21. The system of claim 18, wherein said device encrypts said data related to the information displayed on the local display unit.

22. The system of claim 18, wherein said device responds to a signal from the remote computer station.

23. The system of claim 22, wherein said device prevents transmission of said formed data through said network.

24. The system of claim 18, wherein the remote computer station stores said converted data in a frame buffer.

25. The system of claim 18, wherein the remote computer station decrypts said converted data.

26. The system of claim 18, wherein the remote computer station decompresses said converted data.

27. The system of claim 18, wherein the local display unit is a component of a local computer station.

28. The system of claim 18, wherein the local display unit is a digital camera.

29. The system of claim 28, wherein said digital camera is a digital video camera.

30. The system of claim 18, wherein the local display unit is an endoscope.

31. The system of claim 18, wherein said device comprises a computer usable medium having computer readable program code means embodied in said computer usable medium for causing an application program to execute on a controller.

32. The system of claim 18, wherein said device comprises an interface card.

33. The system of claim 18, wherein said device comprises a connector.

34. A computer program product for enabling monitoring of information displayed on a local display unit at a remote computer station, said computer program product comprising:
a computer usable medium having computer readable program code means embodied in said computer usable medium for causing an application program to execute on a controller that controls the local display unit, said computer readable program code means comprising:
a computer readable first program code means for causing said controller to form data related to the information displayed on the local display unit into a data transfer protocol format; and
a computer readable second program code means for causing said controller to transmit said formed data through a network to the remote computer station.

35. The computer program product of claim 34, wherein said computer usable medium further comprises:
a computer readable third program code means for causing said controller to capture said data related to the information displayed on the local display unit.

36. The computer program product of claim 34, wherein said computer usable medium further comprises:
a computer readable third program code means for causing said controller to compress said data related to the information displayed on the local display unit.

37. The computer program product of claim 34, wherein said computer usable medium further comprises:
a computer readable third program code means for causing said controller to encrypt said data related to the information displayed on the local display unit.

38. The computer program product of claim 34, wherein said computer usable medium further comprises:
a computer readable third program code means for causing said controller to respond to a signal from the remote computer station.

39. The computer program product of claim 38, wherein said computer usable medium further comprises:
a computer readable fourth program code means for causing said controller to prevent transmission of said formed data through said network.

40. An interface card for enabling monitoring of information displayed on a local display unit at a remote computer station, comprising:
an integrated circuit, said integrated circuit comprising:
a first logic circuit for forming data related to the information displayed on the local display unit into a data transfer protocol format; and
a second logic circuit for transmitting said formed data through a network to the remote computer station.

41. The interface card of claim 40, wherein said integrated circuit further comprises:
a third logic circuit for capturing said data related to the information displayed on the local display unit.

42. The interface card of claim 40, wherein said integrated circuit further comprises:
a third logic circuit for compressing said data related to the information displayed on the local display unit.

43. The interface card of claim 40, wherein said integrated circuit further comprises:
a third logic circuit for encrypting said data related to the information displayed on the local display unit.

44. The interface card of claim 40, wherein said integrated circuit further comprises:
a third logic circuit for responding to a signal from the remote computer station.

45. The interface card of claim 44, wherein said integrated circuit further comprises:
a fourth logic circuit preventing transmission of said formed data through said network.

46. The interface card of claim 40, wherein said integrated circuit comprises an application specific integrated circuit.

47. The interface card of claim 40, wherein said integrated circuit comprises a field programmable gate array.

48. A connector for enabling monitoring of information displayed on a local display unit at a remote computer station, comprising:
a port for connecting the connector to a network;
an inductive signal clamp for connecting to a visual display link of the local display unit; and
an integrated circuit, said integrated circuit comprising:
a first logic circuit for capturing data related to the information displayed on the local display unit;
a second logic circuit for forming said captured data into a data transfer protocol format;
a third logic circuit for interfacing between said second logic circuit and said network; and
a fourth logic circuit for transmitting said formed data through said network to the remote computer station.

49. The connector of claim 48, wherein said integrated circuit further comprises:
a fifth logic circuit for compressing said data related to the information displayed on the local display unit.

50. The connector of claim 48, wherein said integrated circuit further comprises:
a fifth logic circuit for encrypting said data related to the information displayed on the local display unit.

51. The connector of claim 48, wherein said integrated circuit further comprises:
a fifth logic circuit for responding to a signal from the remote computer station.

52. The connector of claim 51, wherein said integrated circuit further comprises:
a sixth logic circuit for preventing transmission of said formed data through said network.

53. The connector of claim 48, wherein said integrated circuit comprises an application specific integrated circuit.

54. The connector of claim 48, wherein said integrated circuit comprises a field programmable gate array.

55. A connector for enabling monitoring of information displayed on a local display unit at a remote computer station, comprising:
a first port for connecting the connector to a network;
a second port for connecting the connector to the local display unit; and
an integrated circuit, said integrated circuit comprising:
a first logic circuit for forming data related to the information displayed on the local display unit into a data transfer protocol format;
a second logic circuit for interfacing between said first logic circuit and said network; and
a third logic circuit for transmitting said formed data through said network to the remote computer station.

56. The connector of claim 55, wherein said integrated circuit further comprises:
a fourth logic circuit for capturing said data related to the information displayed on the local display unit.

57. The connector of claim 55, further comprising:
a third port for connecting the connector to a local computer station.

58. The connector of claim 55, wherein the connector is a Digital Video Interface connector.

59. The connector of claim 55, wherein said integrated circuit further comprises:
a fourth logic circuit for compressing said data related to the information displayed on the local display unit.

60. The connector of claim 55, wherein said integrated circuit further comprises:
a fourth logic circuit for encrypting said data related to the information displayed on the local display unit.

61. The connector of claim 55, wherein said integrated circuit further comprises:
a fourth logic circuit for responding to a signal from the remote computer station.

62. The connector of claim 55, wherein said integrated circuit further comprises:
a fifth logic circuit for preventing transmission of said formed data through said network.

63. The connector of claim 55, wherein said integrated circuit comprises an application specific integrated circuit.

64. The connector of claim 55, wherein said integrated circuit comprises a field programmable gate array.
